(19) United States
(12) Patent Application Publication
(10) Pub. No.: US 2005/0014023 A1
(43) Pub. Date: Jan. 20, 2005

(54) Aromatic monomer- and conjugated polymer-metal complexes

(76) Inventors: Wanglin Yu, Midland, MI (US); James J. O'Brien, Midland, MI (US)

Correspondence Address: THE DOW CHEMICAL COMPANY;INTELLECTUAL PROPERTY SECTION, P. O. BOX 1967, MIDLAND, MI, 48641-1967, US

(21) Appl. No.: 10/885,979

(22) Filed: Jul. 7, 2004

Related U.S. Application Data
(60) Provisional application No. 60/487,879, filed on Jul. 16, 2003.

(51) Int. Cl. H05B 33/14; C09K 11/06

(52) U.S. Cl. 428/690; 428/917; 313/504; 257/40; 528/394; 528/377; 528/423; 252/301.35; 546/4; 546/10

(57) ABSTRACT

A halogenated or boronated aromatic monomer-metal complex useful for preparing a polymer for light-emitting diode (LED) device is described. The aromatic monomer-metal complex is designed to include a linking group that disrupts conjugation, thereby advantageously reducing or preventing electron delocalization between the aromatic monomer fragment and the metal complex fragment. Disruption of conjugation is often desirable to preserve the phosphorescent emission properties of the metal complex in a polymer formed from the aromatic monomer-metal complex. The resultant conjugated electroluminescent polymer has precisely controlled metal complexation and electronic properties that are substantially or completely independent of those of the polymer backbone.

### CROSS-REFERENCE STATEMENT

This application claims the benefit of U.S. Provisional application No. 60/487,879 filed Jul. 16, 2003.

### BACKGROUND OF THE INVENTION

The present invention relates to an aromatic monomer-metal complex, an aromatic polymer-metal complex that can be prepared from the monomer-metal complex, and an electronic device that contains a film of the polymer-metal complex.

Organic electronic devices are found in a variety of electronic equipment. In such devices, an organic active layer is sandwiched between two electrical contact layers. The active layer emits light upon application of a voltage bias across the contact layers.

Polymers containing pendant metal-complex groups constitute a class of polymers suitable for light emitting applications, particularly in active matrix driven polymeric LED displays. These polymers can be prepared, for example, by first polymerizing a monomer containing a ligand capable of complexing with a metal, then contacting the polymer with an organometallic complexing compound to insert the metal center into the polymer bound ligand. For example, in Macromolecules, Vol. 35, No. 19, 2002, Pei et al. describes a conjugated polymer with pendant bipyridyl groups directly coordinating with various Eu⁺³ α,β-diketones.

Similarly, in WO 02/31896, pp 17-18, Periyasamy et al. describes lanthanide metal-complexed polymers prepared by either a one- or two-step synthetic route. In the one-step route, an MLₙ, emitter is reacted with a polymer having metal-reactive functionality (X) to form a polymer with pendant —X-MLₙ₋1 groups. In the two-step route, a polymer with pendant hydroxyethyl functionality is first condensed with a bipyridyl compound containing carboxylic acid functionality to form a polymer containing bipyridyl ester functionality (X-L′), which is then reacted with MLₙ to form a polymer with pendant X-L′-MLₙ₋₁ functionality.

One of the problems with these metal complexed electroluminescent polymers is the incomplete reaction of pendant ligands with the metal complexing reagent. This inefficient coupling results in unpredictability of the properties of the final polymer due to the difficulty in controlling the degree of metal-ligand complexation. Accordingly, it would be advantageous to prepare a luminescent polymer with precisely controlled metal complexation.

### SUMMARY OF THE INVENTION

The present invention addresses a need by providing in one aspect a halogenated or boronated aromatic monomer-metal complex compound comprising a halogenated or boronated aromatic monomer fragment and a metal complex fragment and represented by the following formula: 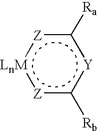
where L is a bidentate ligand; M is Ir, Pt, Rh, or Os; with the proviso that M is Ir, Rh, or Os when n is 2, and M is Pt when n is 1; each Z is independently O, S, or NH; Y is CR_{c} or N, where R_{c} is H or C₁-20-alkyl; and wherein Rₐ and R_{b} are each independently a monovalent substitutent or H, with the proviso that at least one of Rₐ and R_{b} contains a halogenated or boronated aromatic monomer fragment and a linking group that disrupts conjugation between the aromatic monomer fragment and the metal complex fragment.

In a second aspect, the present invention is an electroluminescent polymer having a backbone that comprises a) structural units of an aromatic monomer-metal complex having an aromatic fragment and a metal complex fragment, which structural units are represented by the following formula: 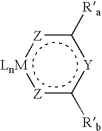
where L is a bidentate ligand; M is Ir, Pt, Rh, or Os; with the proviso that M is Ir, Rh, or Os when n is 2, and M is Pt when n is 1; each Z is independently O, S, or NH; Y is CR_{c} or N, where R_{c} is H or C 1-20-alkyl; and wherein R′ₐ and R′_{b} are each independently a monovalent substitutent or H, with the proviso that at least one of R′ₐ and R′_{b} contains an aromatic group that is part of the polymer backbone and a linking group that disrupts conjugation between the aromatic group and the metal complex fragment; and b) structural units of at least one aromatic comonomer, which polymer is characterized by being conjugated along a polymer backbone created by structural units of the halogenated or boronated aromatic monomer-metal complex and structural units of the at least one aromatic comonomer.

In a third aspect, the present invention is an electronic device comprising a film of a luminescent polymer or of a blend containing the luminescent polymer, which film is sandwiched between an anode and a cathode, which polymer has a backbone with a) structural units of halogenated or boronated aromatic monomer-metal complex having an aromatic fragment and a metal complex fragment, which structural units are represented by the following formula: 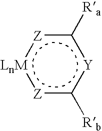
where L is a bidentate ligand; M is Ir, Pt, Rh, or Os; with the proviso that M is Ir, Rh, or Os when n is 2, and M is Pt when n is 1; each Z is independently O, S, or NH; Y is CR_{c} or N, where R_{c} is H or C₁₋₂₀-alkyl; and wherein R′ₐ and R′_{b} are each independently a monovalent substitutent or H, with the proviso that at least one of Rₐ and R_{b} contains an aromatic group that is part of the polymer backbone and a linking group that disrupts conjugation between the aromatic group and the metal complex fragment; and b) structural units of an aromatic comonomer, which polymer is characterized by being conjugated along a polymer backbone created by structural units of the aromatic monomer-metal complex and structural units of the comonomer.

The present invention addresses a need in the art by providing a simple way of preparing a conjugated electroactive polymer with precisely controlled metal complexation. Moreover, the metal complex groups have electronic and/or luminescent properties that are minimally affected by the conjugated polymer backbone due to a conjugation-disrupting linking group inserted between the metal complex and the conjugated polymer backbone.

### BRIEF DESCRIPTION OF DRAWINGS

FIG. 1 depicts a graph of current and light output characterization of a light emitting diode device.

FIG. 2 depicts an electroluminscent spectrum recorded from a light emitting diode device at 200 cd/m².

### DETAILED DESCRIPTION OF THE INVENTION

The first aspect of the present invention is a composition comprising a halogenated or boronated aromatic monomer-metal complex having a halogenated or boronated aromatic monomer fragment and a metal complex fragment and represented by the following formula: 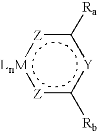
L is a bidentate ligand; M is Ir, Pt, Rh, or Os, preferably Ir; n is 1 when M is Pt and n is 2 when M is Ir, Rh, or Os; each Z is independently O, S, or NH, preferably 0; Y is CR_{c} or N, where R_{c}, is H or C₁-20-alkyl, preferably CR_{c}, more preferably CH. At least one of Rₐ and R_{b} contains a halogenated or boronated aromatic fragment and a linking group that disrupts conjugation between the aromatic fragment and the metal complex.

As used herein, the adjective “boronated” refers to an aromatic fragment or compound that is substituted with a borane group, a boronic acid ester group, or a boronic acid group. Also, “halogenated or boronated” is used herein to refer to an aromatic fragment or compound that contains any of a) at least one halogen group, b) at least one boronated group, or c) at least one halogen and at least one boronated groups.

The halogenated or boronated aromatic monomer-metal complex of the present invention can be thought of as comprising a metal complex fragment and one or more halogenated or boronated aromatic monomer fragments, as illustrated: 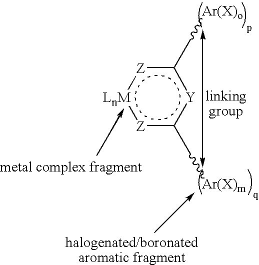
where Ar is an aromatic group; X is a halo atom or boronate group, preferably, each X is either a halogen atom or a boronate group, more preferably, each X is chloro or bromo; the sum of m+o is a positive integer, preferably 1, 2, or 3; more preferably 1 or 2; and the sum of p+q is a positive integer, preferably 1, 2, or 3; more preferably 1 or 2. When p (or q) is 0, Rₐ (or R_{b}) can be any substituent including H.

A preferred halogenated or boronated aromatic monomer-metal complex contains an iridium(III) acetylacetonato fragment—in the formula, M is Ir, each Z is 0, and Y is CH —complexed with a ligand that is preferably selected from the following unsubstituted or substituted compounds: 2-phenylpyridines, 2-benzylpyridines, 2-(2-thienyl)pyridines, 2-(2-furanyl)pyridines, 2,2′-dipyridines, 2-benzo[b]thien-2-yl-pyridines, 2-phenylbenzothiazoles, 2-(1-naphthalenyl)benzothiazoles, 2-(1-anthracenyl)benzothiazoles, 2-phenylbenzoxazoles, 2-(1-naphthalenyl)benzoxazoles, 2-(1-anthracenyl)benzoxazoles, 2-(2-naphthalenyl)benzothiazoles, 2-(2-anthracenyl)benzothiazoles, 2-(2-naphthalenyl)benzoxazoles, 2-(2-anthracenyl)benzoxazoles, 2-(2-thienyl)benzothiazoles, 2-(2-furanyl)benzothiazoles, 2-(2-thienyl)benzoxazoles, 2-(2-furanyl)benzoxazoles, benzo[h]quinolines, 2-phenylquinolines, 2-(2-naphthalenyl)quinolines, 2-(2-anthracenyl)quinolines, 2-(1-naphthalenyl)quinolines, 2-(1-anthracenyl)quinolines, 2-phenylmethylpyridines, 2-phenoxypyridines, 2-phenylthiopyridines, phenyl-2-pyridinylmethanones, 2-ethenylpyridines, 2-benzenemethanimines,2-(pyrrol-2-yl)pyridines, 2-(imidazol-2-yl)-pyridines, 2-phenyl-1H-imidazoles, and 2-phenylindoles.

As used herein, “aromatic compounds” includes both aromatic and heteroaromatic compounds unless otherwise stated. Similarly, the term “aryl” is used herein to include both aryl and heteroaryl groups or compounds unless otherwise stated. Examples of suitable aromatic compounds and structural units from which the halogenated or boronated aromatic monomeric fragment(s) can be prepared can be found in U.S. Pat. No. 6,169,163 (the '163 patent), column 12, lines 23-53; and structures 1-5 from the bottom of columns 11-12 through the middle of columns 13-14, which teachings are incorporated herein by reference.

At least one halogenated or boronated aromatic fragment is attached to the complex fragment through a linking group; if the halogenated or boronated aromatic monomer-metal complex contains two halogenated or boronated aromatic fragments, that is, if Rₐ and R_{b} both include halogenated or boronated aromatic fragments, then it is preferred that each aromatic fragment is attached to the metal complex fragment through a linking group. Moreover, where Rₐ and R_{b} both include halogenated or boronated aromatic fragments, each of these aromatic fragments preferably contain only one halogen group or only one boronate group. The terms “bis(monohalogenated aromatic) monomer-metal complex and “bis(monoboronated aromatic) monomer-metal complex” are used herein to refer specifically to these preferred compounds.

The linking group is a connecting group or atom that disrupts conjugation, thereby inhibiting electron delocalization between the aromatic monomer fragment and the metal complex fragment. This disruption of conjugation between the fragments results in a similar disruption between the complex and the conjugated polymer backbone formed from the aromatic monomer fragment. Disruption of conjugation is often desirable to preserve the phosphorescent emission properties of the metal complex in a polymer formed from the aromatic monomer-metal complex. Such properties could be disadvantageously perturbed if electrons are delocalized between the conjugated polymer backbone and the complex.

The linking group contains a divalent group, which is a substituted or unsubstituted linear, branched, or cyclohydrocarbylene group or a divalent heteroatom or combinations thereof. Examples of linking groups include, alone or in combination, methylene, ethylene, propylene, isopropylene, butylene, isobutylene, t-butylene, cyclopropyl, cyclobutyl, cyclopentyl, and cyclohexyl groups; and heteroatoms such as oxygen and sulfur atoms, SiR₂, where R is a substitutent, and amine groups except for triaryl amines. Preferred linking groups include methylene and oxymethylene groups. As used herein “oxymethylene groups” refer to —OCH₂— or —CH₂O— groups.

If the complex fragment is attached to only one halogenated or boronated aromatic fragment, the latter may contain only one halogen atom or boronate group —in which case the monohalogenated aromatic monomer-metal complex would be suitable as an end-capping group —but preferably contains at least two halogen atoms or at least two boronate groups or at least one halogen atom and one boronate group, more preferably two halogen atoms, most preferably two bromine atoms or two chlorine atoms.

Specific examples of dibrominated and diboronated aromatic monomers that can be modified to bond to the metal complex through a linking group include the compounds illustrated in Tables 1-4 of the' 163 patent, columns 43-49, which teachings are incorporated herein by reference. One of ordinary skill in the art would understand from these teachings how to make monohalogenated, monoboronated, and monohalogenated-monoboronated aromatic monomers.

General Procedure for Preparation of a Dihalogenated Aromatic Monomer-Metal Complex

A halogenated aromatic monomer-metal complex containing a dihalogenated aromatic fragment attached to a metal complex through a linking group can be prepared by coupling a metal complex-reacting dihalogenated aromatic compound (Compound A) with a bis-metal complex (Compound B). These precursors can be prepared as follows:

Scheme for Preparing a Metal Complex-Reacting Dihalogenated Aromatic Compound

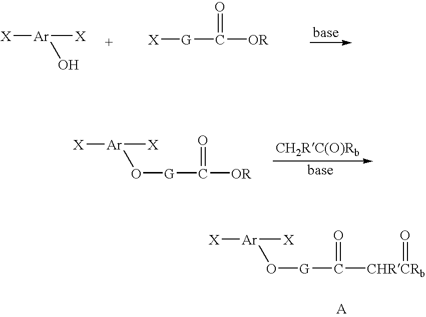

Scheme for Preparation of Bis-Metal Complex 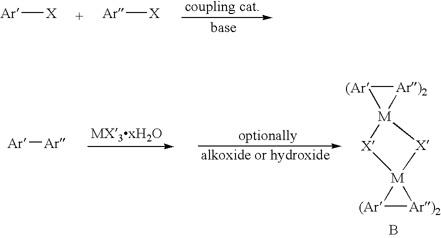
Ar, Ar′, and Ar″ are aromatic moieties which may be the same or different with the proviso that at least one of Ar′ and Ar″ is heteroaromatic; one of Ar′X and Ar″X is an arylhalogen and the other is an arylhalogen or an arylboronate; R_{b} and R are each independently a substituent, preferably a C₁-20 alkyl group or an aryl group, more preferably methyl, ethyl, or phenyl; R′ is independently H, alkyl, or aryl, preferably H or C₁-20 alkyl, more preferably H; G is a bond or contains a divalent group, preferably alkylene or alkylene containing one or more heteroatoms, more preferably alkylene, most preferably methylene; and each X′ is independently halo, —OH, or O-C₁-0-alkyl, preferably each X′ is bromo or chloro. Where X′ is halo, the addition of hydroxy or alkoxy is not necessary; where X′ is —OH or O-C₁-20-alkyl, the addition of hydroxy or alkoxy is preferred.

In the case where G is methylene, Compounds A and B can be coupled in the presence of a base to form the following general structure C.

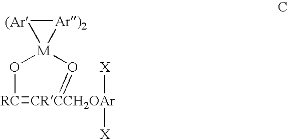

The highlighted oxymethylene group links the dihalogenated aromatic fragment to the metal complex fragment thereby disrupting conjugation between the fragments. In the above illustration, the fragment —CH₂OArX₂ is Rₐ and R is R_{b}.

ArX₂ preferably includes 1,4-dihalophenyls, 1,2-dihalophenyls, 1,3-dihalophenyls, 1,4-dihalonaphthalenyls, 4,4′-dihalobiphenylyls, 2,6-dihalonaphthalenyls, 2,5-dihalofuranyls, 2,5-dihalothienyls, 5,5-dihalo-2,2′-bithienyls, 9,10-dihaloanthracenyls, 4,7-dihalo-2,1,3-benzothiadiazolyls, N,N-di(4-halophenyl) aminophenyls, N,N-di(4-halophenyl)-ρ-methylaminophenyls, 3,6-dihalo-N-substituted carbazolyls, 2,7-dihalo-N-substituted carbazolyls, 3,6-dihalo-dibenzosiloles, 2,7-dihalo-dibenzosiloles, N-substituted-phenothiazine-3,7-diyls, N-substituted-phenoxazines-3,7-diyls, triarylamine-diyls, N,N,N′,N′-tetraaryl-1,4-diaminobenzene-diyls, N,N,N′,N′-tetraarylbenzidine-diyls, arylsilane-diyls, 2,7-dihalo-9,9-disubstituted fluorenyls, where halo is bromo or chloro. ArX₂ is also preferably the diboronate or monohalo-monoboronate analogs of these fragments. In general, ArX₂ is more preferably a dihaloaromatic fragment. The use of the plural (for example, dihalophenyls) indicates that these fragments may include other substituents in addition to the X groups.

It is to be understood that compounds of the formula HOArX₂, in addition to including compounds having an OH group directly attached to an aromatic ring, also include compounds having a divalent group connecting the aromatic ring with the OH group. Compounds where an OH group is directly attached to an aromatic ring are either known (for example, 2,5-dichlorophenol) or can be prepared, for example, by nitration, reduction, diazotization, and hydrolysis of ArX₂. Details of this synthetic route are described by Woo et al. in U.S. Pat. No. 5,708,130, from column 21, lines 41-67 to column 22, lines 1-37, which teachings are incorporated herein by reference.

An example of how to make HOArX₂ where OH is separated from the aromatic ring by a divalent group is by reacting a dihaloaromatic compound with CO and HCl in the presence of AlCl₃ and pressure to form the corresponding dihaloaromatic aldehyde, which can be reduced by any suitable means to the corresponding hydroxy methyl dihaloaromatic compound.

HOArX₂ is preferably 2,5-dibromophenol, 2,5-dichlorophenol, 2,7-dihalo-9,9-disubstituted fluorenes, and 9,9-disubstituted, 2,7-fluorenyl diboronates wherein the fluorene is substituted at the 9,9-positions with one or two hydroxyphenylene groups, as illustrated: 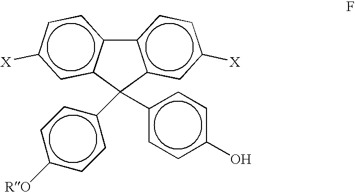
where R″ is H or a substituent, preferably H, alkyl, or aryl, more preferably H or C₁-C₁₀ alkyl. Where R″ is H, the resultant dihalogenated or diboronated aromatic monomer-metal complex may contain two metal complexes per monomer, as illustrated:

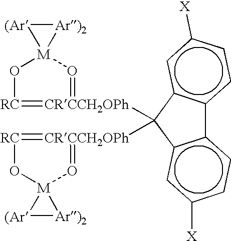

Structure F can be prepared by reacting in the presence of acid a 2,7-dihalogenated 9-fluorenone with HOPh, or blends of R″OPh wherein one or more of the reactants contains HOPh. Preparation of a 2,7-dihalo-9,9-bis(4-hydroxyphenyl) fluorene is described in greater detail in the'163 patent from column 6, lines 51-67 to column 7, lines 1-26, which teaching is incorporated herein by reference.

The following chemical structures I-VIII are specific examples of brominated aromatic monomer-metal complexes containing a dibrominated aromatic fragment attached to an iridium complex through a linking group: 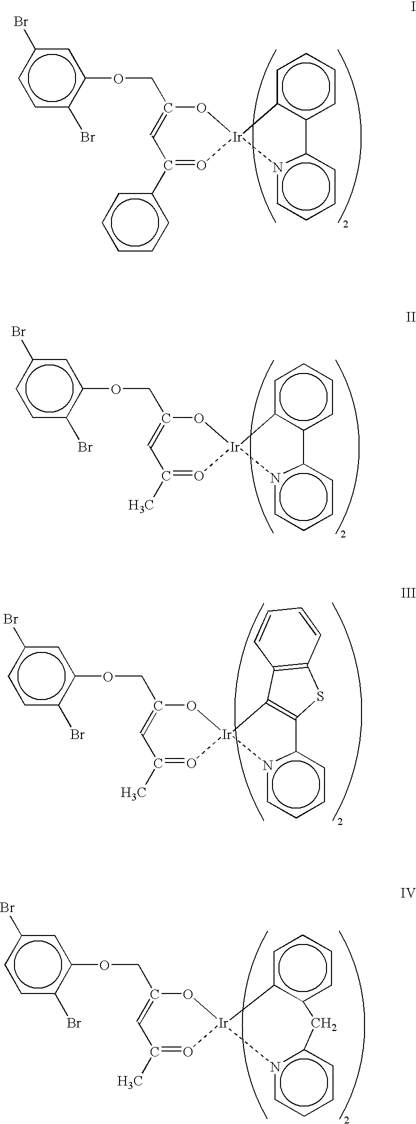 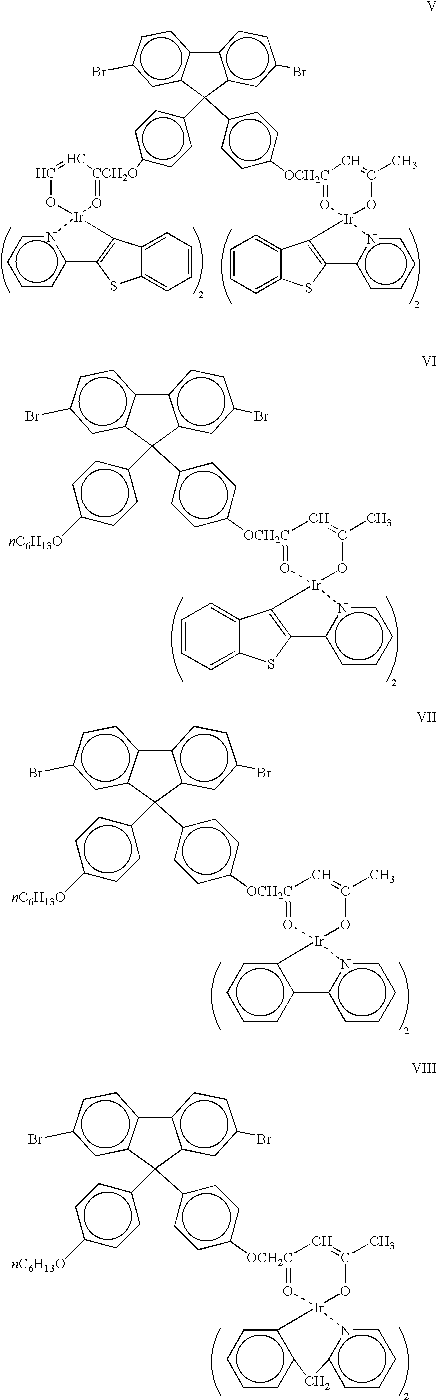
General Procedure for Preparation of a Bis(Monohalogenated Aromatic) Monomer-Metal Complex

A bis(monohalogenated aromatic) monomer-metal complex can be prepared by coupling a bis(monohaloaryl) dione with the bis metal complex B. A bis(monohaloaryl) dione can be prepared as follows: 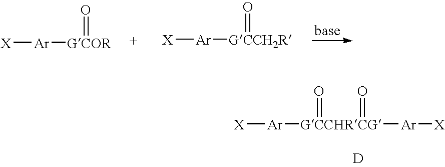
where at least one of the G's contains a non-conjugated divalent group; preferably each G′ independently contains a non-conjugated divalent group, preferably alkylene, or alkylene containing one or more heteroatoms, more preferably alkylene or oxyalkylene, most preferably methylene or oxymethylene.

The bis(monohalogenated aromatic) monomer-metal complex can be also be prepared by coupling a bis(monohaloaryl) diester with the bis metal complex B. Bis(monohaloaryl) diester E can be prepared by esterification of malonic acid and a hydroxylated aromatic halide, as shown: 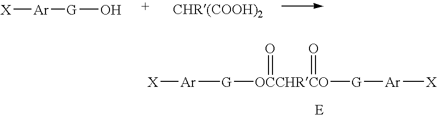
where R′ is as previously defined and G is a bond or a divalent group, preferably a —CH₂-group or a bond; more preferably a bond.

The following chemical structures illustrate specific examples of bis(monohalogenated aromatic) monomer-metal complexes: 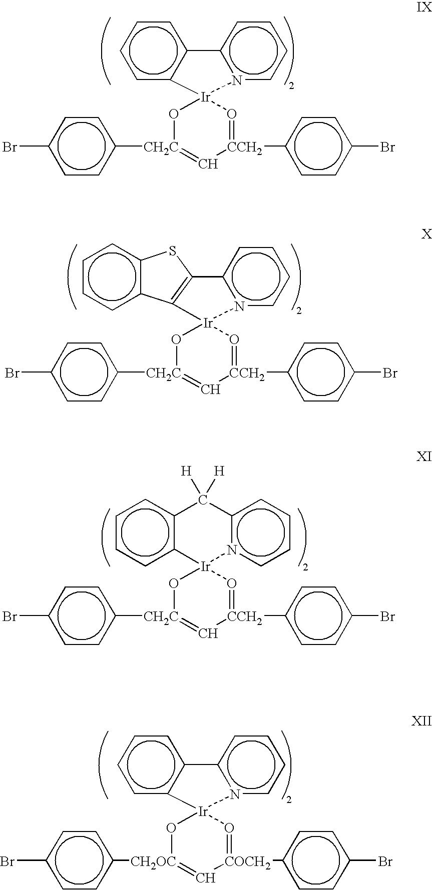
In each of the structures IX-XI, conjugation is disrupted by a methylene group. In structure XII, conjugation is disrupted by an oxymethylene group. In IX-XI cases, Rₐ and R_{b} are each —CH₂ArX; in XII, Rₐ and R_{b} are each —OCH₂ArX.

Though not preferred, it is also possible to disrupt conjugation partially, as is the case where, for example, only one of the monobrominated aromatic fragments is attached to the metal complex fragment through a linking group, as illustrated in structure XIII.

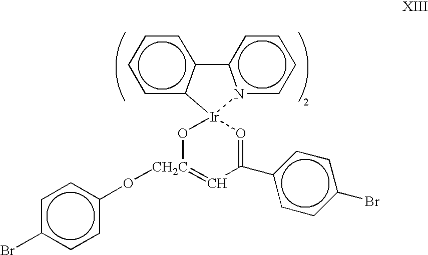

Where the number of halo atoms or boronate groups of the halogenated or boronated aromatic monomer fragment exceeds two, the resultant polymer will normally contain branching or crosslinking or both. Structure XIV is an illustration of a tribrominated aromatic monomer-metal complex.

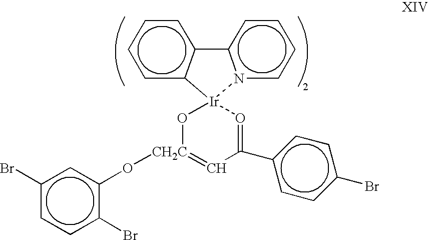

Structure XV is an illustration of a monobrominated aromatic monomer-metal complex. 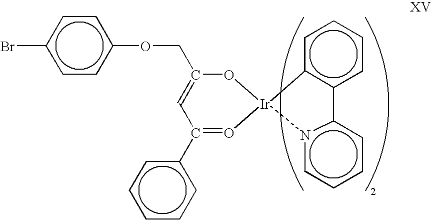
Conjugated Luminescent Polymers Containing Metal Complexes

The halogenated or boronated aromatic monomer-metal complex is a precursor for a metal-complexed conjugated luminescent polymer, which can be a homopolymer, a copolymer, a terpolymer, etc., and which can be prepared by any of a number of means. For example, the polymer can be prepared by a Suzuki coupling reaction, exemplified in the '163 patent, column 41, lines 50-67 to column 42, lines 1-24.

In the present case, the Suzuki coupling reaction can be carried out by reacting, in the presence of a catalyst, preferably a Pd/triphenylphosphine catalyst such as tetrakis(triphenylphosphine)palladium(0), any of a) a halogenated aromatic monomer-metal complex with a boronated aromatic compound; or b) a boronated aromatic monomer-metal complex with an halogenated aromatic compound; or c) a halogenated and a boronated aromatic monomer-metal complex with a halogenated and a boronated aromatic compound; or d) a halogenated aromatic monomer-metal complex with a boronated aromatic monomer-metal complex. It is to be understood from this description that more than one reactive aromatic monomer-metal complex and more than one co-monomer may be used.

Preferably, the Suzuki coupling reaction is carried out by reacting at least one, preferably one dihalogenated or bis(monohalogenated) aromatic monomer-metal complex with at least one, preferably more than one diboronated aromatic compound. The aromatic groups of the one or more co-monomers —which form structural units of the resultant polymer —may be the same as or different from, preferably different from, the aromatic groups associated with the halogenated or boronated aromatic monomer-metal complex. Where the aromatic groups of the co-monomers that become part of the polymer backbone are the same as the aromatic groups of the aromatic monomer-metal complex that become part of the polymer backbone, the less preferred homopolymer having a backbone with pendant, incorporated or encapped groups is formed. Where the aromatic groups are different, the preferred copolymer (or terpolymer, etc.) having a backbone with pendant, incorporated or encapped groups is formed.

As suggested above, it is also possible, and sometimes preferable, to prepare a polymer having structural units of more than two monomers by including in the reaction mixture a variety of halogenated and boronated monomers. It may also be desirable to prepare a conjugated luminescent polymer with end-capped metal complexing. Such a polymer can be prepared from a monohalogenated or monoboronated aromatic monomer-metal complex.

Polymerization can also be carried out by coupling one or more dihalogenated aromatic monomer-metal complexes with one or more dihalogenated aromatic compounds in the presence of a nickel salt, as described in the' 163 patent, column 11, lines 9-34, which description is incorporated herein by reference.

The aromatic co-monomers that can be used to couple with the halogenated or boronated or halogenated and boronated aromatic monomer-metal complex is nearly endless but a representative list includes, 1,4-diXbenzenes, 1,3-diXbenzenes, 1,2-diXbenzenes 4,4′-diXbiphenyls, 1,4-diXnaphthalenes, 2,6-diXnaphthalenes, 2,5-diXfurans, 2,5-diXthiophenes, 5,5-diX-2,2′-bithiophenes, 9,10-diXanthracenes, 4,7-diX-2, 1,3-benzothiadiazoles, diX triaryl amines including N,N-di(4-Xphenyl) anilines, N,N-di(4-Xphenyl)-ρ-tolylamines; and N-diXphenyl-N-phenylanilines, 3,8-diX-N-substituted carbazoles, 4,7-diX-N-substituted carbazoles, 3,8-diX-dibenzosiloles, 4,7-diX-dibenzosiloles, N-substituted-3,7-diXphenothiazines, N-substituted-3,7-diXphenoxazines, 3,8-diXdibenzosiloles, 4,7-diXdibenzosiloles, diX-N,N,N′,N′-tetraaryl-1,4-diaminobenzenes, diX-N,N,N′,N′-tetraarylbenzidines, diXarylsilanes, and 2,7-diX-9,9-disubstituted fluorenes, including fluorenes in which the 9,9-substituents combine to form a ring structure, and combinations thereof, where each X is independently halo or boronate, preferably bromo or chloro or boronate, more preferably bromo or boronate.

A particularly suitable diboronated aromatic group is a 9,9-disubstituted 2,7-fluorenyl diboronate. As previously stated, the use of the plural (for example, dihalophenyls) indicates that these compounds may include other substituents in addition to the halo or boronate groups.

The resultant polymer contains structural units of the aromatic monomer-metal complex and structural units of the comonomer. As used herein, the term “structural units” is used to refer to the remnant of the monomer that constitutes polymer backbone after polymerization of the monomer. A structural unit of the aromatic group that is attached to the metal complex through a linking group is represented by the following structure: 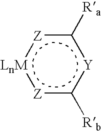
where L, n, M, Z, and Y are as previously defined, and at least one of R′ₐ and R′_{b} contains an aromatic group that is part of the polymer backbone, preferably a phenyl group or a 9,9-disubstituted fluorene-2,7-diyl; and a linking group, G, that disrupts conjugation between the aromatic group and the metal complex fragment. The other of R′ₐ and R′_{b} may also contain an aromatic group that is part of the polymer backbone or may be a monovalent substituent, including H. Where only one of R′ₐ and R′_{b} contains an aromatic group such as a phenylene moiety incorporated into the backbone of the polymer, the following structural unit is formed:

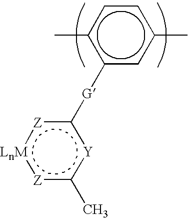

Where both of R′ₐ and R′_{b} contains an aromatic group such as a phenyl moiety incorporated into the backbone of the polymer, the following structural unit is formed:

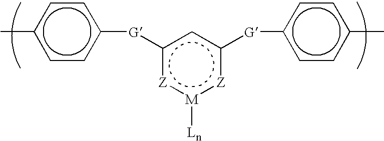

Similarly, a structural unit of a benzene comonomer that is incorporated into the polymer backbone through the 1,4-positions is a 1,4-phenylene group; a structural unit of a 9,9-disubstituted fluorene comonomer that is incorporated into the polymer backbone through the 2,7-positions is a 9,9-disubstituted fluorene-2,7-diyl group, as illustrated:

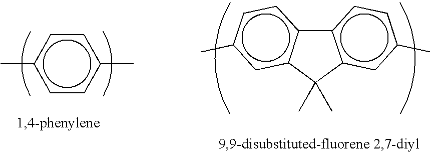

Accordingly, the structural units corresponding to the above listed co-monomers are 1,4-phenylenes, 1,3-phenylenes, 1,2-phenylenes, 4,4′-biphenylenes, naphthalene-1,4-diyls, naphthalene-2,6-diyl, furan-2,5-diyls, thiophene-2,5-diyls, 2,2′-bithiophene-5,5-diyls, anthracenes-9,10-diyls, 2,1,3-benzothiadiazoles-4,7-diyls, N-substituted carbazole-3,8-diyls, N-substituted carbazole-4,7-diyls, dibenzosilole-3,8-diyls; dibenzosilole-4,7-diyls, N-substituted-phenothiazine-3,7-diyls, N-substituted-phenoxazines-3,7-diyls, triarylamine-diyls including triphenylamine-4,4′-diyls, diphenyl-p-tolylamine-4,4′-diyls, and N,N-diphenylaniline-3,5-diyls, N,N,N′,N′-tetraaryl-1,4-diaminobenzene-diyls, N,N,N′,N′-tetraarylbenzidine-diyls, arylsilane-diyls, and 9,9-disubstituted fluorenes-2,7-diyls. However, it is to be understood that the polymer is not limited by the manner in which it is made.

The metal complex may be pendant to, incorporated within, or endcapped to the polymer backbone. The metal complex is pendant to the conjugated backbone when the polymer is prepared from a dihalogenated aromatic fragment attached to the metal complex through a linking group such as illustrated in structures I-VIII, is incorporated into the conjugated backbone through linking group such as illustrated in structures IX-XII, and encaps the conjugated backbone through a linking group such as illustrated in structure XV.

The resultant polymer has a conjugated backbone with metal complexation that can be precisely controlled because preferably at least 90%, more preferably at least 95%, and most preferably 100% of the structural units of the aromatic monomer-metal complex contain a metal complex that is pendant to, incorporated within, and/or endcapped to the polymer backbone. At one extreme, a homopolymer prepared from any of Structures I-VIII would have a pendant group for every phenylene group in the polymer backbone. At the other extreme, the conjugated copolymer can contain a single metal complex group, as is the case where, for example, the aromatic compound-metal complex depicted in structure XV is used to endcap a conjugated polymer containing a single halogen or boronate group. For the preferred halogenated or boronated, or halogenated and boronated aromatic monomer-metal complexes such as those depicted in structures I-XII and XV, the metal complex is insulated from the conjugated backbone due to the absence of direct delocalization between the ligand and the polymer backbone, which insulation preserves the luminescent properties of the metal complex.

Preferably, the ratio of structural units of halogenated or boronated aromatic monomer-metal complex to structural units of the comonomer is preferably at least 0.01:99.99, more preferably at least 0.1:99.9, and most preferably at least 1:99; and preferably not greater than 20:80, more preferably not greater than 10:90.

When the polymer is prepared using bis(monohalogenated aromatic) monomer-metal complexes, conjugation is not only disrupted between the metal complex and the backbone, but within the backbone itself. Thus, the terms “conjugated polymer” and “conjugated polymer backbone” are used loosely to mean that the polymer backbone has electrons that are delocalized throughout at least two adjacent structural units, preferably at least five adjacent structural units, more preferably at least ten adjacent structural units.

The polymers of the present invention preferably have a weight average molecular weight M_{w} of at least 5000 Daltons, more preferably at least 10,000 Daltons, more preferably at least 50,000 Daltons, and most preferably at least 100,000 Daltons; and preferably less than 2,000,000 Daltons. M_{w} is determined using gel permeation chromatography against polystyrene standards.

The polymer of the present invention can be combined with one or more other polymers to make a blend. Examples of suitable blending polymers include homo- or co-polymers (including terpolymers or higher) of polyacrylates, polymethacrylates, polystyrenes, polyesters, polyimides, polyvinylenes, polycarbonates, polysiloles, poly(dibenzosiloles), polyvinyl ethers and esters, fluoropolymers, polycarbazoles, polyarylene vinylenes, polyarylenes, polythiophenes, polyfurans, polypyrroles, polypyridines, polyfluorenes, and combinations thereof.

The polymer or blend of the present invention can be combined with a sufficient amount of solvent to make a solution which is useful, for example, as an ink. The amount of solvent varies depending upon the solvent itself and the application, but is generally used at a concentration of at least 80 weight percent, more preferably at least 90 weight percent, and most preferably at least 95 weight percent, based on the weight of the luminescent polymer, the optional additives or modifiers, and the solvent.

Examples of suitable solvents for the polymer and the modifier include benzene; mono-, di- and trialkylbenzenes including C₁₋₁₂-alkyl benzenes, xylenes, mesitylene, cyclohexylbenzene, and diethylbenzene; furans including tetrahydrofuran and 2,3-benzofuran; 1,2,3,4-tetrahydronaphthalene; cumene; decalin; durene; chloroform; limonene; dioxane; alkoxybenzenes including anisole, and methyl anisoles; alkyl benzoates including methyl benzoate; biphenyls including isopropyl biphenyl; pyrrolidinones including cyclohexylpyrrolidinone; imidazoles including dimethylimidazolinone; and fluorinated solvents; and combinations thereof. More preferred solvents include C₁₋₈-alkyl benzenes, cyclohexylbenzene, xylenes, mesitylene, 1,2,3,4-tetrahydronaphthalene, methyl benzoate, isopropyl biphenyl, and anisole, and combinations thereof.

In a typical application, the ink formulation can be deposited on a substrate such as indium-tin-oxide (ITO) glass having a hole transporting material disposed thereon. The solvent is then evaporated, whereupon the ink forms a thin film of the luminescent polymer. The film is used as an active layer in an organic light-emitting diode (OLED) device, which can be used to make a display such as a self-emissive flat panel display. The film is also useful in other electronic devices including light sources, photovoltaic cells, and field effect transistor devices.

The following examples are for illustrative purposes only and are not intended to limit the scope of the invention.

### EXAMPLE 1

### Preparation of a Dibromobenzene Monomer-Iridium Complex (Structure III)

A. Preparation of 1-(2,5-Dibromo)phenoxy-2,4-pentadione Precursor

A mixture of 2,5-dibromophenol (12.6 g, 50 mmol), ethyl bromoacetate (8.0 g, 48 mmol), and potassium carbonate (20 g, 150 mmol) in acetone (150 mL) was refluxed under nitrogen for 24 h. After being cooled to room temperature, the reaction mixture was filtered and washed with acetone. After the removal of the solvent, the residue was recrystallized from ethanol to give ethyl(2,5-dibromophenoxy)acetate.

In the next step, sodium hydride (4.56 g, 0.19 mol) was added to a solution of anhydrous acetone (12.3 g, 0.213 mol) dissolved in 250 mL of dimethoxyethane under nitrogen at room temperature. The mixture was stirred at room temperature for 15 minutes, after which ethyl(2,5-dibromophenoxy)acetate (12.0 g, 0.0335 mol) was added in one portion. The reaction mixture was stirred under nitrogen at 80° C. for 16 hours. After cooling, the pH of the mixture was adjusted to <7 with 2N HCl. The product was extracted with chloroform and dried over anhydrous sodium sulfate. Solvent was removed in vacuo and the product was recrystallized from ethanol (containing a small amount of toluene) to yield the 1-(2,5-dibromo)phenoxy-2,4-pentadione (4.6 g, 38.8% yield, 99.9% purity by HPLC).

B. Preparation of a bis-Iridium Complex

Sodium bicarbonate (2M aqueous solution, 125 mL, 0.25 mol) and Pd(0)(PPh₃)₄ (0.33 g, 0.3 mol) were added to a solution of benzothiophene-2-boronic acid (17.8 g, 0.1 mol), 2-bromopyridine (23.7 g, 0.15 mole) and Aliquat™ 336 phase transfer catalyst (5 g) in toluene (400 mL). The reaction mixture was stirred at 100° C. for 18 hours. After cooling to room temperature, the organic phase was washed, and the solvent removed in vacuo. The residue was poured over methanol to precipitate the product, which was recrystallized from toluene to yield 6.2 g (76% yield) of 99.4% pure 2-benzo[b]thien-2-yl-pyridine by HPLC.

Iridium (III) chloride hydrate (4.5 g, 15.1 mmol, Ir %=55.11) and 2-benzo[b]thien-2-yl-pyridine (5.38 g, 25.5 mmol) were dispersed in a mixture of 2-ethoxyethanol (45 mL) and water (15 mL). The mixture was refluxed under nitrogen for 20 h. The reaction mixture was cooled to room temperature and was filtered. The solid was washed with 1N HCl aqueous solution and methanol and was then dried under vacuum at room temperature overnight to give 7.56 g (91% yield) of the bis-Iridium Complex as light brown solid.

C. Preparation of Dibromobenzene Monomer-Iridium Complex

The bis-iridium complex prepared (5.5 g, 4.24 mmol), the 1-(2,5-dibromo)phenoxy-2,4-pentanedione (2.83 g, 8.48 mmol) and anhydrous sodium carbonate (7.0 g) were dispersed in 2-ethoxylethanol (350 mL). The mixture was degassed with nitrogen at room temperature for 15 min and then heated to reflux for 3 hours. After cooling, the product was precipitated with methanol (300 mL). Crude product (7.1 g) was obtained as a orange solid by filtration and drying in vacuo at 40° C. overnight. The crude product was re-dissolved in a minimum amount of methylene chloride and purified on a silica gel column eluted by methylene chloride to give 4.7 g of a brown solid. The solid was further purified by flush chromography on silica gel eluted by a mixture of methylene chloride and hexane (6:4). The final product was obtained as orange-red powder at 3.2 g (39.3% yield). HPLC analysis indicated a purity of 99.5%.

### EXAMPLE 2

### Preparation of Metal Complex Containing Polymer

To a stirred mixture of 9,9-di(1-hexyl)fluorene-2,7-diboronic acid ethylene glycol ester (1.9268 g, 4.08 mmol), 2,7-dibromo-9,9-di(1-hexyl)fluorene (1.7150 g, 3.48 mmol), N,N-diphenyl-1,3-dibromoaniline (0.1624 g, 0.40 g), dibromobenzene monomer-iridium complex made in Section C in Example 1 (0.160 g, 0.12 mmol), Aliquat® 336 phase transfer catalyst (0.75 g) in toluene (50 mL) was added tetrakis(triphenylphosphine)palladium(0) (3.6 mg) and 2M aqueous sodium carbonate solution (11 ml) under nitrogen. The reaction mixture was stirred at 101° C. under nitrogen for 20 h, whereupon bromobenzene (0.15 g in 10 mL of toluene) was added to cap the polymer under the same reaction conditions for 3 h. Then, phenylboronic acid (0.4 g) and tetrakis(triphenylphosphine)palladium(0) (3 mg of dissolved in 10 mL of toluene) was added to double cap the polymer under the same reaction conditions for overnight. After the reaction mixture was allowed cool to about 50° C., the organic layer was washed with warm water three times then poured into 2 L of methanol with stirring.

The yellow polymer fibers were collected by filtration, washed with methanol, and dried in vacuo at 50° C. overnight. The polymer was re-dissolved in toluene (100 mL) and the solution was passed through a column packed with celite and silica gel layers and eluted with toluene. The combined eluates were concentrated to about 100 mL, and then poured into 2 L of stirred methanol. The polymer were collected as fibers and dried in vacuo at 50° C overnight. The polymer was re-dissolved in toluene (100 mL) and re-precipitated in 2 L of methanol. After the filtration and drying in vacuo at 50° C. overnight, 2.3 g of yellow fibers were obtained. M_{w}=330,000, polydispersity index (M_{w}/Mₙ)=2.66.

### EXAMPLE 3

### Light-Emitting Devices of a Metal Complex Containing Polymer

A thin film of poly(ethylenedioxythiophene)/polystyrenesulfonic acid (PEDOT) was spin-coated on a ITO (indium tin oxide)-coated glass substrate, at a thickness of 80 nm. Then, a film of the metal complex containing polymer made in Example 2 was spin-coated on the PEDOT film at a thickness of 80 m from a solution in xylenes. After drying, a thin layer (3 nm) of LiF was deposited on the top of the polymer layer by thermal evaporation, followed by the deposition of a cathode calcium (10-nm thick). An additional aluminum layer was applied by evaporation to cover the calcium cathode. By applying a bias (ITO wired positively) on the resultant device, red light emission was obtained. The brightness of the emission reached 200 cd/m² at about 9 V with the luminance efficiency of 2 cd/A. The device reached the brightness of 1000 cd/m² at ˜12 V at the luminance efficiency of 1.8 cd/A.

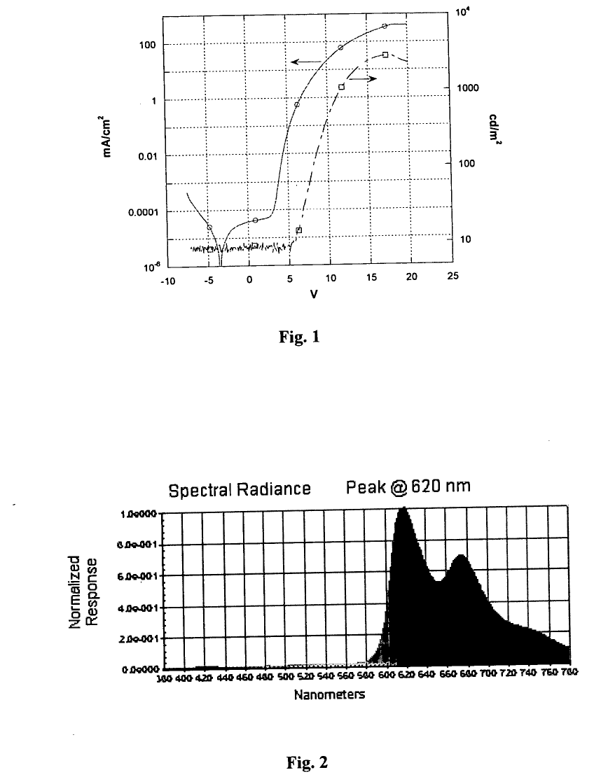

FIG. 1 illustrates the current and light output properties of the device. FIG. 2 illustrates the electroluminescence (EL) spectrum recorded at the brightness of 200 cd/m², which corresponds to the 1931 CIE color coordinates of (x=0.673, y=0.319).

The EL spectrum is similar to that of the OLED device made from an iridium complex small molecular material, bis(2-(2′benzo[b]thienyl)pyridinato-N,C3′) iridium(acetylacetonate), which has the same basic structure as the metal complex containing polymer in Example 3. The spectral similarity indicates that the emission of the device comes from the electrophosphorescence of the metal complex fragments in the polymer. The absence of the emission from the backbone of the fluorene-based polymer in the blue region also indicates a nearly complete energy transfer from the backbone to the metal complex fragments.

1. A halogenated or boronated aromatic monomer-metal complex compound comprising a halogenated or boronated aromatic monomer fragment and a metal complex fragment and represented by the following formula: 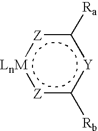
where L is a bidentate ligand; M is Ir, Pt, Rh, or Os; with the proviso that M is Ir, Rh, or Os when n is 2, and M is Pt when n is 1; each Z is independently O, S, or NH; Y is CR_{c} or N, where R_{c} is H or C₁₋₂₀-alkyl; and wherein Rₐ and R_{b} are each independently a monovalent substitutent or H, with the proviso that at least one of Rₐ and R_{b} contains a halogenated or boronated aromatic monomer fragment and a linking group that disrupts conjugation between the aromatic monomer fragment and the metal complex fragment.

2. The compound of claim 1 wherein M is Ir, Z is 0; Y is CH; n is 2; and L is selected from the group consisting of substituted or unsubstituted 2-phenylpyridines, 2-benzylpyridines, 2-(2-thienyl)pyridines, 2-(2-furanyl)pyridines, 2,2′-dipyridines, 2-benzo[b]thien-2-yl-pyridines, 2-phenylbenzothiazoles, 2-(1-naphthalenyl)benzothiazoles, 2-(1-anthracenyl)benzothiazoles, 2-phenylbenzoxazoles, 2-(1-naphthalenyl)benzoxazoles, 2-(1-anthracenyl)benzoxazoles, 2-(2-naphthalenyl)benzothiazoles, 2-(2-anthracenyl)benzothiazoles, 2-(2-naphthalenyl)benzoxazoles, 2-(2-anthracenyl)benzoxazoles, 2-(2-thienyl)benzothiazoles, 2-(2-furanyl)benzothiazoles, 2-(2-thienyl)benzoxazoles, 2-(2-furanyl)benzoxazoles, benzo[h]quinolines, 2-phenylquinolines, 2-(2-naphthalenyl)quinolines, 2-(2-anthracenyl)quinolines, 2-(1-naphthalenyl)quinolines, 2-(1-anthracenyl)quinolines, 2-phenylmethylpyridines, 2-phenoxypyridines, 2-phenylthiopyridines, phenyl-2-pyridinylmethanones, 2-ethenylpyridines, 2-benzenemethanimines,2-(pyrrol-2-yl)pyridines, 2-(imidazol-2-yl)-pyridines, 2-phenyl-1H-imidazoles, and 2-phenylindoles.

3. The compound of claim 2 wherein L is selected from the group consisting of 2-phenylpyridines, 2-benzylpyridines, and 2-benzo[b]thien-2-yl-pyridines; Rₐ is -G-ArXₒ and R_{b} is-G-ArXm, methyl, ethyl, or phenyl, where G is —OCH₂—, —CH₂O—, —CH₂—, or —O—; o is 1 or 2 and m is 0 or 1; each Ar is independently an aromatic group, and each X is independently a Cl, a Br, or a boronate group.

4. The compound of claim 3 wherein Rₐ is-G-ArX₂ and R_{b} is methyl, ethyl, or phenyl, where each X is Cl or Br, and Ar contains a phenyl or fluorenyl group.

5. The compound of claim 3 wherein Rₐ and R_{b} are each —OCH₂—ArX or —CH₂—ArX; X is Cl or Br, and Ar contains a phenyl or fluorenyl group.

6. The compound of claim 1 which is prepared by contacting a dihalogenated aromatic precursor (A) with a bis-metal complex (B) in the presence of base and under such conditions to make the composition; wherein n is 2; L is Ar′-Ar″, where Ar′ and Ar″ are aromatic moieties which may be the same or different, with the proviso that at least one of Ar′ and Ar″ is heteroaromatic; Z is 0; Y is CR′, wherein R′ is H, alkyl, or aryl; R_{b} is a substituent; and Rₐ is-G-O—ArX₂, wherein Ar is an aromatic group, each X′ is independently Cl or Br or O-alkyl or OH, and G is a bond or a divalent group; wherein (A) and (B) are represented by the following structures:

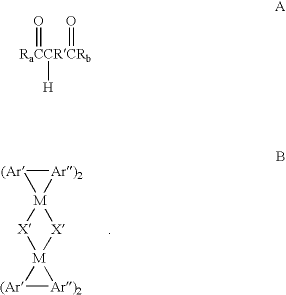

7. The compound of claim 6 wherein M is Ir, each R′ is H, L is selected from the group consisting of substituted or unsubstituted 2-phenylpyridines, 2-benzylpyridines, and 2-benzo[b]thien-2-yl-pyridines; G is a methylene group;
R_{b} is methyl or phenyl; and Rₐ is selected from the group consisting of: 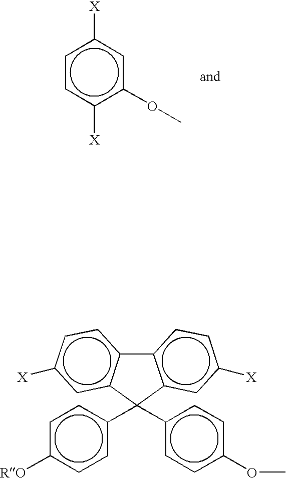
where X is Cl, Br, or boronate, and R″ is-aryl, —C₁-20-alkyl, or

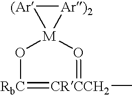

8. The compound of claim 1 which is prepared by coupling a bis-metal complex (B) with either a dihalodiaryldione (D) or a dihalodiarly ester (E), wherein n is 2; L is Ar′-Ar″, where Ar′ and Ar″ are aromatic moieties which may be the same or different, with the proviso that at least one of Ar′ and Ar″ is heteroaromatic; Z is 0; Y is CR′, where R′ is H, alkyl, or aryl; each of Rₐ and R_{b} is X—Ar-G′—when B is coupled with D and each of Rₐ and R_{b} is X—Ar-G-O— when B is coupled with E; wherein each X is independently Cl or Br, each Ar is independently an aromatic group, at least one of the G's includes a non-conjugated divalent group, and each G is a bond or a non-conjugated divalent group; where B, D, and E are represented by the following structures:

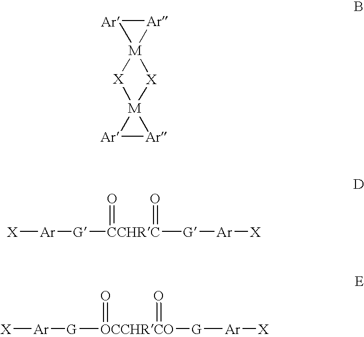

9. The compound of claim 8 wherein L is selected from the group consisting of substituted or unsubstituted 2-phenylpyridines, 2-benzylpyridines, and 2-benzo[b]thien-2-yl-pyridines; each G′ is a methylene group or 0; each G is a bond or a methylene group; Ar is phenyl and X is Cl, Br, or boronate.

10. An electroluminescent polymer having a backbone that comprises a) structural units of an aromatic monomer-metal complex having an aromatic fragment and a metal complex fragment, which structural units are represented by the following formula: 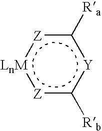
where L is a bidentate ligand; M is Ir, Pt, Rh, or Os; with the proviso that M is Ir, Rh, or Os when n is 2, and M is Pt when n is 1; each Z is independently O, S, or NH; Y is CR_{c} or N, where R_{c} is H or C₁-20-alkyl; and wherein Rₐ and R_{b} are each independently a monovalent substitutent or H, with the proviso that at least one of R′ₐ and R′_{b} contains an aromatic group that is part of the polymer backbone and a linking group that disrupts conjugation between the aromatic group and the metal complex fragment; and b) structural units of at least one aromatic comonomer, which polymer is characterized by being conjugated along a polymer backbone created by structural units of the aromatic monomer-metal complex and structural units of the at least one aromatic comonomer.

11. The polymer of claim 10 wherein M is Ir, Z is 0; Y is CH; n is 2; and L is selected from the group consisting of substituted or unsubstituted 2-phenylpyridines, 2-benzylpyridines, 2-(2-thienyl)pyridines, 2-(2-furanyl)pyridines, 2,2′-dipyridines, 2-benzo[b]thien-2-yl-pyridines, 2-phenylbenzothiazoles, 2-(1-naphthalenyl)benzothiazoles, 2-(1-anthracenyl)benzothiazoles, 2-phenylbenzoxazoles, 2-(1-naphthalenyl)benzoxazoles, 2-(1-anthracenyl)benzoxazoles, 2-(2-naphthalenyl)benzothiazoles, 2-(2-anthracenyl)benzothiazoles, 2-(2-naphthalenyl)benzoxazoles, 2-(2-anthracenyl)benzoxazoles, 2-(2-thienyl)benzothiazoles, 2-(2-furanyl)benzothiazoles, 2-(2-thienyl)benzoxazoles, 2-(2-furanyl)benzoxazoles, benzo[h]quinolines, 2-phenylquinolines, 2-(2-naphthalenyl)quinolines, 2-(2-anthracenyl)quinolines, 2-(1-naphthalenyl)quinolines, 2-(1-anthracenyl)quinolines, 2-phenylmethylpyridines, 2-phenoxypyridines, 2-phenylthiopyridines, phenyl-2-pyridinylmethanones, 2-ethenylpyridines, 2-benzenemethanimines,2-(pyrrol-2-yl)pyridines, 2-(imidazol-2-yl)-pyridines, 2-phenyl-1H-imidazoles, and 2-phenylindoles; and at least 90% of the structural units of the aromatic monomer-metal complex contain a metal complex that is pendant to, incorporated within, and/or endcapped to the polymer backbone.

12. The polymer of claim 11 wherein the structural units of the at least one aromatic co-monomer is selected from the group consisting of 1,4-phenylenes, 1,3-phenylenes, 1,2-phenylenes, 4,4,-biphenylenes, naphthalene-1,4-diyls, naphthalene-2,6-diyl, furan-2,5-diyls, thiophene-2,5-diyls, 2,2′-bithiophene-5,5-diyls, anthracenes-9,10-diyls, 2,1,3-benzothiadiazoles-4,7-diyls, N-substituted carbazole-3,6-diyls, N-substituted carbazole-2,7-diyls, dibenzosilole-3,6-diyls, dibenzosilole-2,7-diyls, N-substituted-phenothiazine-3,7-diyls, N-substituted-phenoxazines-3,7-diyls, triarylamine-diyls, N,N,N′,N′-tetraaryl-1,4-diaminobenzene-diyls, N,N,N′,N′-tetraarylbenzidine-diyls, arylsilane-diyls, and 9,9-disubstituted fluorenes-2,7-diyls The polymer of claim 12 wherein the backbone contains structural units selected from two or more of the group consisting of phenylenes, 9,9-disubstituted fluorenyl-2,7-diyls, bis(phenyl-iridium complexes), phenyl-iridium complexes, N-substituted carbazole-3,8-diyls, N-substituted carbazole-4,7-diyls, N,N-diphenylaniline-3,5-diyls, triphenylamine-4,4′-diyls, diphenyl-p-tolylamine-4,4′-diyls, and N-substituted-phenoxazines-3,7-diyls.

13. A composition comprising a blend of the electroluminesecent polymer of claim 10 and a solvent for the polymer.

14. The composition of claim 14 wherein the solvent is selected from the group consisting of benzene; monoalkylbenzenes, dialkylbenzenes, trialkylbenzenes, furans, cumene, decalin, durene, chloroform, limonene, dioxanes, alkoxybenzenes, alkyl benzoates, biphenyls, pyrrolidinones, imidazoles, and fluorinated solvents, and combinations thereof.

15. The composition of claim 15 wherein the solvent is selected from the group consisting of C₁-8-alkyl benzenes, cyclohexylbenzene, xylenes, mesitylene, 1,2,3,4-tetrahydronaphthalene, methyl benzoate, isopropyl biphenyl, and anisole, and combinations thereof.

16. The composition of claim 14 which further includes at least one other polymer in addition to the electroluminescent polymer.

17. The polymer of claim 10 which is prepared by condensing a dihalogenated aromatic monomer and optionally a diboronated aromatic monomer with a halogenated or boronated aromatic monomer-metal complex represented by the following formula: 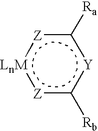
where L is a bidentate ligand; M is Ir, Pt, Rh, or Os; with the proviso that M is Ir, Rh, or Os when n is 2, and M is Pt when n is 1; each Z is independently O, S, or NH; Y is CR_{c} or N, where R_{c} is H or C₁-20-alkyl; and wherein at least one of Rₐ and R_{b} contains a halogenated or boronated aromatic monomer fragment and a linking group that disrupts conjugation between the aromatic monomer fragment and the metal complex fragment.

18. The polymer of claim 10 which is prepared by reacting a diboronated aromatic monomer and optionally a dihalogenated monomer with a halogenated or boronated aromatic monomer-metal complex represented by the following formula: 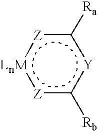
where L is a bidentate ligand; M is Ir, Pt, Rh, or Os; with the proviso that M is Ir, Rh, or Os when n is 2, and M is Pt when n is 1; each Z is independently O, S, or NH; Y is CR_{c} or N, where R_{c} is H or C₁₋₂₀-alkyl; and wherein at least one of Rₐ and R_{b} contains a halogenated or boronated aromatic monomer fragment and a linking group that disrupts conjugation between the aromatic monomer fragment and the metal complex fragment.

19. An electronic device comprising a film of a luminescent polymer or of a blend containing the luminescent polymer, which film is sandwiched between an anode and a cathode, which polymer has a backbone with a) structural units of an aromatic monomer-metal complex having an aromatic fragment and a metal complex fragment, which structural units are represented by the following formula: 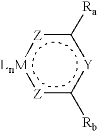
where L is a bidentate ligand; M is Ir, Pt, Rh, or Os; with the proviso that M is Ir, Rh, or Os-when n is 2, and M is Pt when n is 1; each Z is independently O, S, or NH; Y is CR_{c} or N, where R_{c} is H or C₁₋₂₀-alkyl; and wherein Rₐ and R_{b} are each independently a monovalent substitutent or H, with the proviso that at least one of Rₐ and R_{b} contains a halogenated or boronated aromatic monomer fragment and a linking group that disrupts conjugation between the aromatic monomer fragment and the metal complex fragment; and b) structural units of an aromatic comonomer, which polymer is characterized by being conjugated along a polymer backbone created by structural units of the halogenated or boronated aromatic monomer-metal complex and structural units of the comonomer.
